(19) United States
(12) Patent Application Publication
(10) Pub. No.: US 2017/0217524 A1
(43) Pub. Date: Aug. 3, 2017

(54) PEDAL CONNECTION MECHANISM AND ELECTRIC BALANCING VEHICLE USING THE SAME

(71) Applicant: Better Wheels, LLC., Las Vegas, NV (US)

(72) Inventor: Zhijun YANG, Shenzhen (CN)

(73) Assignee: Better Wheels, LLC., Las Vegas, NV (US)

(21) Appl. No.: 15/361,084

(22) Filed: Nov. 25, 2016

(30) Foreign Application Priority Data
Feb. 3, 2016 (CN) 201620112263.6

(51) Int. Cl. B62J 25/00; B62M 7/12; B62J 6/00; B62K 11/00; B62K 23/08

(52) U.S. Cl. CPC B62J 25/00; B62K 11/007; B62K 23/08; B62J 6/00; B62M 7/12; B62K 2202/00; B62K 2204/00; B62K 2207/00

(57) ABSTRACT

A pedal connection mechanism includes a left and a right pedal, and a transverse connecting member. The first cylindrical shaft is provided along the bottom of the left pedal. The left side of the top wall of the transverse connecting member is provided with the first support member. The second cylindrical shaft is provided along the bottom of the right pedal. The right side of the top wall of the transverse connecting member is provided with the second support member. The present invention further provides an electric balancing vehicle using this pedal connection mechanism. The left pedal and the right pedal are not connected with each other through an intermediate shaft. Their motion statuses are controlled respectively by the left foot and the right foot independently. The transverse connecting member shares the weight of a human body. The force distributes evenly. The balancing vehicle is flexible and durable.

### TECHNICAL FIELD

The present invention relates to a technical field of a transportation vehicle, in particular, to a pedal connecting mechanism and an electric balancing vehicle using the same.

### BACKGROUND

An electric balancing scooter is also known as a somatosensory scooter, Segway, or the like. It is a popular transportation vehicle among modern people and can meet people's requirements on leisure, entertainment, and environmental friendliness. On the basis of the principle of “dynamic stability”, the electric balancing vehicle determines the vehicle's position and condition by using a gyroscope and an acceleration sensor, and calculates appropriate instructions through a sophisticated, high-speed central microprocessor, and then drives motor to make adjustments correspondingly so as to keep balance of the system.

The forms of existing balancing vehicles are diverse and various.

A balancing vehicle equipped with a steering rod is available on the market. In use, the user controls the direction of movement of the balancing vehicle by adjusting the steering rod. It is complicated and relatively difficult to complete the operation of adjusting the steering rod. In addition, it is easy to cause wear between the steering rod and controlling connection parts, leading to the failure of the balancing vehicle. Furthermore, since the user needs to hold the steering rod without stretching and other movements, the fun of playing is reduced.

The Chinese Patent Application No. 201520567850.X discloses a double-wheeled balancing vehicle, which does not need the steering rod to adjust the vehicle's motion status. However, the left and right pedals of this two-wheeled balancing vehicle are connected by an intermediate shaft. In use, the whole weight of a human body is born by the intermediate shaft. The twisting of the body of the balancing vehicle may easily cause damage, even crack, to the intermediate shaft. The balancing vehicle with this structure is prone to failure and has low stability. The reliability and security of this balancing vehicle also need to be improved. In addition, the design of the balancing vehicle with the intermediate shaft has a low flexibility and a large reaction error.

### SUMMARY

In order to avoid the shortcomings of the prior art, the present invention provides a pedal connection mechanism. This pedal connection mechanism provides a transverse connecting member on the bottom of the left pedal and the right pedal. The left pedal and the right pedal are not connected with each other by the intermediate shaft. Rather, they are two independent subjects. Their motion statuses are respectively controlled by the left foot and the right foot independently. The transverse connecting member shares the weight of the human body. The force distributes evenly. Such design is novel and reasonable, and is beneficial for expanding the lifetime.

Another purpose of the present invention is to provide an electric balancing vehicle using the pedal connection mechanism. In this electric balancing vehicle, the bottom of the pedal is provided with a transverse connecting member. When it is in use, the transverse connecting member bares the weight of the human body. The force distributes evenly. Structural damage of the balancing vehicle is reduced. It has a good stability, and is reliable and safe.

The first purpose of the present invention can be achieved by the following technical solution:

A pedal connection mechanism, includes a left pedal, a right pedal, and a transverse connecting member. A first cylindrical shaft is transversely provided along a center of a bottom of the left pedal. A left side of a top wall of the transverse connecting member is provided with a first support member, the first support member is provided with a first recess matching the first cylindrical shaft. The first cylindrical shaft is provided inside the first recess, such that the left pedal is connected to the first support member in a rotatable manner. A second cylindrical shaft is transversely provided along a center of a bottom of the right pedal. A right side of the top wall of the transverse connecting member is provided with a second support member, the second support member is provided with a second recess matching the second cylindrical shaft. The second cylindrical shaft is provided inside the second recess, such that the right pedal is connected to the second support member in a rotatable manner.

Preferably, the first cylindrical shaft includes two transversely provided first cylinders. The two first cylinders are symmetrically provided on both sides of a bottom of the left pedal. Correspondingly, the left side of the top wall of the transverse connecting member is provided with two first support members. The two first support members are all provided with a first recess matching the first cylinder. The left pedal is connected to the first support member in a rotatable manner. The second cylindrical shaft includes two transversely provided second cylinders, the two second cylinder symmetrically provided on both sides of a bottom of the right pedal. Correspondingly, the right side of the top wall of the transverse connecting member is provided with two second support members. The two second support members are all provided with a second recess matching the second cylinder. The right pedal is connected to the second support member in a rotatable manner.

Preferably further comprises a plurality of first resilient members and a plurality of second resilient members. One end of each of the first resilient members is connected to the bottom of the left pedal, while the other end thereof is connected to the left side of the top wall of the transverse connecting member correspondingly. One end of each of the second resilient members is connected to the bottom of the right pedal, while the other end thereof is connected to the right side of the top wall of the transverse connecting member.

Preferably, the first resilient members and the second resilient members are all springs.

Preferably, the number of the first resilient members is four. One end of the four first resilient members respectively is connected to four corners of the bottom of the left pedal. The other end thereof respectively is connected to the left side of the top wall of the transverse connecting member correspondingly. The number of the second resilient members is four. One end of the four second resilient member respectively is connected to four corners of the bottom of the right pedal. The other end thereof respectively is connected to the right side of the top wall of the transverse connecting member correspondingly.

Preferably, the transverse connecting member is a flat panel. Along the direction of the longitude of the flat panel, both sides of a middle portion of the flat panel symmetrically and inwardly recess.

Another purpose of the present invention can be achieved by the following technical solution.

An electric balancing vehicle using the pedal connection mechanism includes a housing, a pedal connection mechanism, wheels, motors, main boards, and a power supply.

An interior of the housing is provided with an accommodating cavity. A top surface thereof is provided with a first notch and a second notch that are bilaterally symmetrical with each other. The first notch matches the left pedal. The second notch matches the right pedal.

The pedal connection mechanism is provided inside the accommodating cavity, wherein the left pedal is provided inside the first notch, and the right pedal is provided inside the second notch.

The plurality of wheels includes a left wheel and a right wheel, each of which is respectively provided on a left side and a right side of the housing.

The plurality of motors includes a first motor and a second motor. The first motor is provided inside the left wheel. A power output terminal thereof is connected to a left wheel drive. After receiving a signal transmitted from the main board, the first motor controls a motion status of the left wheel. The second motor is provided inside the right wheel. A power output terminal thereof is connected to the right wheel drive. After receiving a signal transmitted from the main board, the first motor controls a motion status of the right wheel.

The plurality of main boards includes a left main board and a right main board. The left main board is on a bottom of the left pedal, and is provided in parallel with the left pedal. The right main board is on a bottom of the right pedal, and is provided in parallel with the right pedal. The left main board includes a first sensor, a first signal processor, and at least one first touch sensing switch. The first sensor senses a motion status of the left pedal. A signal output terminal thereof is connected to a signal input terminal of the first signal processor. A signal output terminal of the first signal processor is connected to a first signal input terminal of the first motor. A signal output terminal of the first touch sensor is connected to a second signal input terminal of the first motor.

The right main board includes a second sensor, a second signal processor, and at least one second touch sensing switch. The second sensor senses a motion status of the right pedal. A signal output terminal thereof is connected to a signal input terminal of the second signal processor. A signal output terminal the second signal processor is connected to a first signal input terminal of the first motor. A signal output terminal of the second touch sensor is connected to a second signal input terminal of the first motor.

The power supply is provided inside the accommodating cavity, providing energy for the electric balancing vehicle.

Preferably, the first sensor includes the first gyroscope and the first acceleration sensor. A signal output terminal of the first gyroscope is connected to the first signal input terminal of the first signal processor. A signal output terminal of the first acceleration sensor is connected to the second signal input terminal of the first signal processor. The second sensor includes the second gyroscope and the second acceleration sensor. A signal output terminal of the second gyroscope is connected to the first signal input terminal of the second signal processor. A signal output terminal of the second acceleration sensor is connected to the second signal input terminal of the second signal processor.

Preferably, the number of the first touch sensing switch is two. The number of the second touch sensing switch is two.

Preferably, a power display is provided outsides a top surface or a sidewall of the housing. A night light is provided outsides the sidewall of the housing.

The technical solution provided by the present invention can have the following advantageous effects:

(1) In the pedal connection mechanism provided by the present invention, a transverse connecting member is provided on the bottom side of the left pedal and the right pedal. The left pedal and the right pedal are respectively connected to the transverse connecting member rotatably. The left pedal and the right pedal are independent relative to each other. When the balancing vehicle is in use, the weight applied by the human body to the pedal is conveyed to the transverse connecting member. The transverse connecting member bears the weight of the human body. The force distributes evenly. This avoids the defect of the prior art in which the left and right pedals are connected through an intermediate shaft that bears the weight of the human body. Thus, the intermediate shaft is likely to wear and even crack. The balancing vehicle manufactured using such pedal connection mechanism is reliable, safe, and durable.

(2) In the pedal connection mechanism provided by the present invention, a resilient member is provided between the pedal and the transverse connecting member, such that after the user steps on the pedal, a buffer is provided, thereby the comfort level is improved.

(3) The pedal connection mechanism provided by the present invention, can not only be used in a double-wheeled balancing vehicle but also in a three-wheeled balancing vehicle, a four-wheeled balancing vehicle, or other suitable types of vehicles. It has a wide range of applications, a high practical utility, and a great commercial prospect.

(4) In the electric balancing vehicle provided by the present invention, both the left and the right pedal respectively are provided with a sensing system correspondingly. The sensing system of the left pedal senses motion status of the left foot. The sensing system of the right pedal senses motion status of the right foot. Moreover, the signal is transmitted to the respective signal processor. After the signal processor generates the terminal signal, the signal is transmitted to the motor. The motion of the wheel is controlled by the frequency output of the motor. The left and the right pedals are provided with independent sensing systems, such that the reaction of the balancing vehicle is more flexible and accurate, with reduced error. Moreover, the electric balancing vehicle with such structure does not need to be provided with a direction pole. the user can control the motion of the balancing vehicle with motions of the body and feet. In terms of the flexibility of operation, the user can better enjoy the fun of playing. The balancing vehicle is aesthetic and nice.

(5) In the electric balancing vehicle provided by the present invention, the left main board is provided with two first touch sensing switches. The right main board is provided with two second touch sensing switches. One of the first touch sensing switches and one of the second touch sensing switches are spare switches. Providing spare switches is convenient and practical, because it avoids the defect of providing only one switch in which once the switch is broken, the balancing vehicle cannot start up.

(6) In the electric balancing vehicle provided by the present invention, the user can clearly know the power status of the balancing vehicle through the power display, and can recharge in time, avoiding the situation in which the vehicle is stopped due to the lack of power. Moreover, a night light is further provided on the housing. The night light can improve the safety when the user is using the electric balancing vehicle at night.

### BRIEF DESCRIPTION OF THE DRAWINGS

FIG. 1 is a front view of a pedal connection mechanism provided by an embodiment of the present invention.

FIG. 2 is a left view of the pedal connection mechanism according to an embodiment of the present invention;

FIG. 3 is a right view of the pedal connection mechanism according to an embodiment of the present invention;

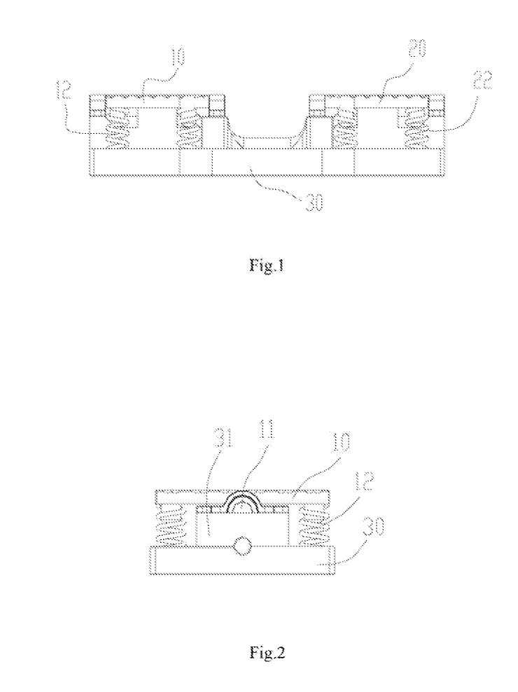

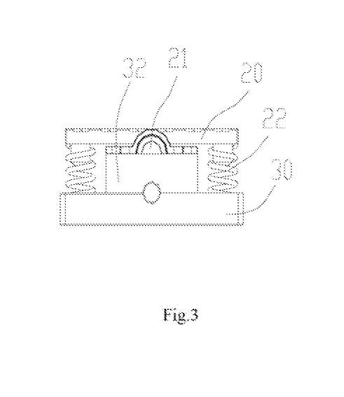

Reference symbols: 10, left pedal; 11, first cylindrical shaft; 12, first resilient member; 20, right pedal; 21, second cylindrical shaft; 22, second resilient member; 30, transverse connecting member; 31, first support member; 32, second support member.

Figures hereinafter are incorporated into the specification and constitute a part of the specification, showing embodiments in accordance with the present invention, together with the specification explaining the principle of the present invention.

### DETAILED DESCRIPTION

Hereinafter, further detailed descriptions are made for the present invention through embodiments in conjunction with drawings.

As shown in FIG. 1, a pedal connection mechanism includes left pedal 10, right pedal 20, and transverse connecting member 30. First cylindrical shaft 11 is transversely provided along the center of the bottom of left pedal 10. The left side of the top wall of transverse connecting member 30 is provided with first support member 31. First support member 31 is provided with a first recess matching first cylindrical shaft 11. First cylindrical shaft 11 is provided inside the first recess, such that left pedal 10 is connected to first support member 31 in a rotatable manner. Second cylindrical shaft 21 is transversely provided along the center of the bottom of right pedal 20. The right side of the top wall of transverse connecting member 30 is provided with second support member 32. Second support member 32 is provided with the second recess matching second cylindrical shaft 21. Second cylindrical shaft 21 is provided inside the second recess, such that right pedal 20 is connected to second support member 32 in a rotatable manner.

Hereafter, the arranging manner of this pedal connection mechanism is further illustrated.

First cylindrical shaft 11 includes two transversely provided first cylinders. The two first cylinders symmetrically provided on both sides of the bottom of left pedal 10. Correspondingly, the left side of the top wall of transverse connecting member 30 is provided with two first support members 31. Two first support members 31 are all provided with the first recesses matching the first cylinders. Left pedal 10 is connected to first support member 31 in a rotatable manner. Second cylindrical shaft 21 includes two transversely provided second cylinders. The two second cylinders are symmetrically provided on both sides of the bottom of right pedal 20. Correspondingly, the right side of the top wall of transverse connecting member 30 is provided with two second support members 32. Two second support members 32 are all provided with the second recesses matching the second cylinders. Right pedal 20 is connected to second support member 32 in a rotatable manner.

Preferably, first resilient members 12 and second resilient members 22 are also included. One end of first resilient member 12 is connected to the bottom of left pedal 10, and the other end correspondingly is connected to the left side of the top wall of transverse connecting member 30. One end of second resilient member 22 is connected to the bottom of right pedal 20, and the other end thereof is correspondingly connected to the right side of the top wall of transverse connecting member 30. First resilient member 12 and second resilient member 22 may all be provided as springs, but not limited to springs, and can be provided as other suitable resilient members. The resilient member makes the user get a certain buffer after stepping on the pedal, so as to improve the comfort level. The number of first resilient members 12 is four. One end of the four first resilient members 12 is connected to four corners of the bottom of left pedal 10 respectively, and the other end thereof is correspondingly connected to the left side of the top wall of transverse connecting member 30 respectively. The number of second resilient members 22 is four. One end of four second resilient members 22 is connected to four corners of the bottom of right pedal 20 respectively, and the other end thereof is correspondingly connected to the right side of the top wall of transverse connecting member 30.

Preferably, transverse connecting member 30 can be provided as a flat panel, along the longitude direction of the flat panel, both sides of the middle portion recess symmetrically and inwardly.

In the pedal connection mechanism provided by the embodiment of the present invention, the bottom of left pedal 10 and right pedal 20 is provided with transverse connecting member 30. Left pedal 10 and right pedal 20 is rotatably connected to transverse connecting member 30 respectively. Left pedal 10 and right pedal 20 are independent from each other. During the use of the balancing vehicle, the weight applied to the pedal by the human body is conveyed to transverse connecting member 30, such that transverse connecting member 30 bears the weight of the human body, and thus the force distributes evenly. This avoids the defect of the prior art in which in the balancing vehicle, the left and right pedals are connected through a middle shaft, and the middle shaft bears the weight of the human body, and therefore the middle shaft is likely to wear and even crack. balancing vehicle made by this pedal connection mechanism is reliable, safe, and durable. Moreover, this pedal connection mechanism not only can be used in a double-wheeled balancing vehicle, but also can be used in a three-wheeled balancing vehicle, a four-wheeled balancing vehicle, or other suitable types of vehicles. It has a wide range of applications, a high practical utility, and a great commercial prospect.

The present invention further provides an electric balancing vehicle using this pedal connection mechanism, which includes a housing, a pedal connection mechanism, wheels, motors, main boards, and a power supply. The interior of the housing is provided with an accommodating cavity, and the top surface thereof is provided with the first notch and the second notch that are bilaterally symmetrical with each other. The first notch matches left pedal 10. The second notch matches right pedal 20. The pedal connection mechanism is provided within the accommodating cavity. Among others, left pedal 10 is provided inside the first notch, and right pedal 20 is provided inside the second notch. The wheels include a left wheel and a right wheel. They are provided on the left and right sides of the housing respectively. The motors include the first motor and the second motor. The first motor is provided within the left wheel, with its power output terminal being connected to the left wheel drive. After receiving the signal transmitted from the main board, the first motor controls the motion status of the left wheel. The second motor is provided within the right wheel, with its power output terminal being connected to the right wheel drive. After receiving the signal transmitted from the main board, the second motor controls the motion status of the right wheel. Main boards include a left main board and a right main board. The left main board is provided on the bottom of left pedal 10, and is provided in parallel with left pedal 10. Right main board 20 is provided on the bottom of right pedal 20, and is provided in parallel with right pedal 20. The left main board includes a first sensor, a first signal processor, and at least one first touch sensing switch. The first sensor senses the motion status of left pedal 10, with its signal output terminal being connected to the first signal processor. The signal output terminal of the first signal processor is connected to the first signal input terminal of the first motor. The signal output terminal of the first touch sensor is connected to the second signal input terminal of the second motor. The right main board includes a second sensor, a second signal processor, and at least one second touch sensing switch. The second sensor sensing the motion status of the right pedal, with its signal output terminal being connected to the signal input terminal of the second signal processor. The signal output terminal of the second signal processor is connected to the first signal input terminal of the second motor. The signal output terminal of the second touch sensor is connected to the second signal input terminal of the second motor. The power supply is provided within the accommodating cavity, providing energy for the electric balancing vehicle.

Hereinafter, the providing manners of the left main board and the right main board are further illustrated.

The first sensor includes the first gyroscope and the first acceleration sensor. The signal output terminal of the first gyroscope is connected to the first signal input terminal of the first signal processor. The signal output terminal of the first acceleration sensor is connected to the second signal input terminal of the first signal processor. The second sensor includes the second gyroscope and the second acceleration sensor. The signal output terminal of the second gyroscope is connected to the first signal input terminal of the second signal processor. The signal output terminal of the second acceleration sensor is connected to the second signal input terminal of the second signal processor.

Preferably, the number of first touch sensing switches is two. The number of second touch sensing switches is two. Among others, one first touch sensing switch and one second touch sensing switch are spare switches. Providing spare switches is convenient and practical, because it avoids the defect of providing only one switch in which once the switch is broken, the balancing vehicle cannot start up.

Moreover, a power display is provided outside the top surface or the sidewall of the housing. A night light is provided outside the sidewall of the housing. the user can clearly know the power status of the balancing vehicle through the power display, and can recharge in time, so as to avoid the situation in which the vehicle is stopped due to the lack of power. Moreover, a night light is further provided on the housing. The night light can improve the safety when the user is using the electric balancing vehicle at night.

The working principle of the electric balancing vehicle provided by the present invention is as follows:

During the operation of the electric balancing vehicle, when the user's left foot steps on left pedal 10, touching the touch sensing switch on the left main board such that the touch sensing switch is turned on. When the user's right foot steps on right pedal 20, touching the touch sensing switch on right main board such that the touch sensing switch is turned on the user's left foot steps on left pedal 10, such that left pedal 10 inclines forwards or backwards, Meanwhile, the left main board which is parallel connected to the bottom of left pedal 10 inclines forwards or backwards along with left pedal 10. At this time, the first sensor on the left main board detects the motion status of left pedal 10 constantly, and transmits the signal to the first signal processor on left main board. The first signal processor feeds back to the first motor. The motion status of the left wheel is adjusted correspondingly according to the power output of the first motor. On the other hand, the user's right foot steps on right pedal 20, such that right pedal 20 inclines forwards or backwards. Meanwhile, the right main board which is parallel connected to the bottom of right pedal 20 inclines forwards or backwards along with right pedal 20. At this time, the first sensor on the right main board detects the motion status of right pedal 20, and transmits the signal to the second signal processor on the right main board. The second signal processor feeds back to the second motor. The motion status of the right wheel is adjusted correspondingly according to the power output of the second motor. When the user steps hard on left pedal 10 and right pedal 20 simultaneously to the forward, the left wheel and the right wheel keep rolling forwards, and the balancing vehicle moves forwards. When the user steps hard on left pedal 10 and right pedal 20 backwards simultaneously, the left wheel and the right wheel keep rolling backwards, and the balancing vehicle moves backwards. However, when the stepping motion of the user makes motion statuses of left pedal 10 and right pedal 20 inconsistent, the balancing vehicle will turn. Meanwhile, the first sensor and the second sensor will feed back the swing magnitude of the user's body, such that the first motor and the second motor obtain different power outputs, so as to adjust the velocity of the balancing vehicle.

For a person with ordinary skill in the art, other kinds of corresponding alternations and modifications can be made according to technical solutions and concepts described above. All of these alternations and modifications should belong to the scope of the claims of the present invention.

What is claimed is:

1. A pedal connection mechanism, comprising a left pedal, a right pedal, and a transverse connecting member;
a first cylindrical shaft being transversely provided along a center of a bottom of the left pedal; a left side of a top wall of the transverse connecting member being provided with a first support member,
the first support member being provided with a first recess matching the first cylindrical shaft; the first cylindrical shaft being provided inside the first recess, such that the left pedal is connected to the first support member in a rotatable manner; and
a second cylindrical shaft being transversely provided along a center of a bottom of the right pedal; a right side of the top wall of the transverse connecting member being provided with a second support member,
the second support member being provided with a second recess matching the second cylindrical shaft; the second cylindrical shaft being provided inside the second recess, such that the right pedal being connected to the second support member in a rotatable manner.

2. The pedal connection mechanism according to claim 1, wherein the first cylindrical shaft includes two transversely provided first cylinders, the two first cylinders being symmetrically provided on both sides of a bottom of the left pedal; correspondingly, the left side of the top wall of the transverse connecting member being provided with two first support members, the two first support members all being provided with a first recess matching the first cylinder; the left pedal being connected to the first support member in a rotatable manner; and
wherein the second cylindrical shaft includes two transversely provided second cylinders, the two second cylinder symmetrically provided on both sides of a bottom of the right pedal; correspondingly, the right side of the top wall of the transverse connecting member being provided with two second support members, the two second support members all being provided with a second recess matching the second cylinder; the right pedal being connected to the second support member in a rotatable manner.

3. The pedal connection mechanism according to claim 1, further comprising a first resilient member and a second resilient member; one end the first resilient member being connected to the bottom of the left pedal, the other end thereof being connected to the left side of the top wall of the transverse connecting member correspondingly; one end of the second resilient member being connected to the bottom of the right pedal, the other end thereof being connected to the right side of the top wall of the transverse connecting member.

4. The pedal connection mechanism according to claim 3, wherein the first resilient member and the second resilient member are all springs.

5. The pedal connection mechanism according to claim 3, wherein a number of the first resilient members is four, one end of each of the four first resilient members respectively being connected to four corners of the bottom of the left pedal, the other end thereof being respectively connected to the left side of the top wall of the transverse connecting member correspondingly; and
wherein a number of the second resilient members is four, one end of each of the four second resilient members respectively being connected to four corners of the bottom of the right pedal, the other end thereof respectively being connected to the right side of the top wall of the transverse connecting member correspondingly.

6. The pedal connection mechanism according to claim 1, wherein the transverse connecting member is a flat panel, wherein along a direction of a longitude of the flat panel, both sides of a middle portion thereof symmetrically and inwardly recess.

7. An electric balancing vehicle using the pedal connection mechanism according to claim 1, comprising a housing, a pedal connection mechanism, a plurality of wheels, a plurality of motors, a plurality of main boards, and a power supply;
an interior of the housing being provided with an accommodating cavity, a top surface thereof being provided with a first notch and a second notch that are bilaterally symmetrical with each other; the first notch matching the left pedal; the second notch matching the right pedal;
the pedal connection mechanism being provided inside the accommodating cavity; wherein the left pedal is provided inside the first notch, the right pedal being provided inside the second notch;
the plurality of wheels including a left wheel and a right wheel, both of which respectively being provided on a left side and a right side of the housing;
the plurality of motors including a first motor and a second motor; the first motor being provided inside the left wheel, a power output terminal thereof being connected to a left wheel drive; after receiving a signal transmitted from the main board, the first motor controlling a motion status of the left wheel; the second motor being provided inside the right wheel, a power output terminal thereof being connected to the right wheel drive; after receiving a signal transmitted from the main board, the first motor controlling a motion status of the right wheel,
the plurality of main boards including a left main board and a right main board; the left main board being provided on a bottom of the left pedal, and being provided in parallel with the left pedal; the right main board being provided on a bottom of the right pedal, and is provided in parallel with the right pedal; the left main board including a first sensor, a first signal processor, and at least one first touch sensing switch; the first sensor sensing a motion status of the left pedal, a signal output terminal thereof being connected to a signal input terminal of the first signal processor; a signal output terminal of the first signal processor being connected to a first signal input terminal of the first motor, a signal output terminal of the first touch sensor being connected to a second signal input terminal of the first motor;
the right main board including a second sensor, a second signal processor, and at least one second touch sensing switch; the second sensor sensing a motion status of the right pedal, a signal output terminal thereof being connected to a signal input terminal of the second signal processor; a signal output terminal the second signal processor being connected to a first signal input terminal of the first motor; a signal output terminal of the second touch sensor being connected to a second signal input terminal of the first motor; and
the power supply being provided inside the accommodating cavity, providing energy for the electric balancing vehicle.

8. The electric balancing vehicle according to claim 7, wherein the first sensor includes a first gyroscope and a first acceleration sensor; a signal output terminal of the first gyroscope being connected to a first signal input terminal of the first signal processor; a signal output terminal of the first acceleration sensor being connected to a second signal input terminal of the first signal processor; and
wherein the second sensor includes a second gyroscope and a second acceleration sensor; a signal output terminal of the second gyroscope being connected to a first signal input terminal of the second signal processor; a signal output terminal of the second acceleration sensor being connected to a second signal input terminal of the second signal processor.

9. The electric balancing vehicle according to claim 7, wherein a number of the first touch sensing switch is two; and wherein a number of the second touch sensing switch is two.

10. The electric balancing vehicle according to claim 7, wherein a power display is provided outside a top surface or a sidewall of the housing; and wherein a night light is provided outside the sidewall of the housing.
